(19) United States
(12) Patent Application Publication
(10) Pub. No.: US 2004/0193847 A1
(43) Pub. Date: Sep. 30, 2004

(54) Intra-register subword-add instructions

(76) Inventors: Ruby B. Lee, Princeton, NJ (US); Dale Morris, Steamboat Springs, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/403,863

(22) Filed: Mar. 31, 2003

(51) Int. Cl. G06F 9/00

(52) U.S. Cl. 712/221

(57) ABSTRACT

Intra-register subword add instructions yield results that are a function of a sum having as at least some of its addends unary functions of at least two subwords stored in the same register. For example, one “TreeAdd” instruction yields a sum of all subwords in a register. A “parallel accumulate” PAcc instruction yields a result with four 2-byte result subwords. Each result subword is the sum of 2-byte value in a first operand register and two of eight 1-byte subwords in a second operand register. A “Parallel Accumulate Magnitude” PAccMagLR also yields a result with four 2-byte subwords. Each of these subwords is the sum of a 2-byte value in a first operand register and the absolute values of two 1-byte values in a second operand register. These instructions provide for substantial performance enhancements for motion estimation used in video compression.

### BACKGROUND OF THE INVENTION

The present invention relates to digital-image processing and, more particularly, to evaluating matches between digital images. The invention provides for high throughput motion estimation for video compression by providing a high-speed image-block-match function.

Video (especially with, but also without, audio) can be an engaging and effective form of communication. Video is typically stored as a series of still images referred to as “frames”. Motion and other forms of change can be represented as small changes from frame to frame as the frames are presented in rapid succession. Video can be analog or digital, with the trend being toward digital due to the increase in digital processing capability and the resistance of digital information to degradation as it is communicated.

Digital video can require huge amounts of data for storage and bandwidth for communication. For example, a digital image is typically described as an array of color dots, i.e., picture elements (“pixels”), each with an associated “color” or intensity represented numerically. The number of pixels in an image can vary from hundreds to millions and beyond, with each pixel being able to assume any one of a range of values. The number of values available for characterizing a pixel can range from two to trillions; in the binary code used by computers and computer networks, the typical range is from one bit to thirty-two bits.

In view of the typically small changes from frame to frame, there is a lot of redundancy in video data. Accordingly, many video compression schemes seek to compress video data in part by exploiting inter-frame redundancy to reduce storage and bandwidth requirements. For example, two successive frames typically have some corresponding pixel (“picture-element”) positions at which there is change and some pixel positions in which there is no change. Instead of describing the entire second frame pixel by pixel, only the changed pixels need be described in detail—the pixels that are unchanged can simply be indicated as “unchanged”. More generally, there may be slight changes in background pixels from frame to frame; these changes can be efficiently encoded as changes from the first frame as opposed to absolute values. Typically, this “inter-frame compression” results in a considerable reduction in the amount of data required to represent video images.

On the other hand, identifying unchanged pixel positions does not provide optimal compression in many situations. For example, consider the case where a video camera is panned one pixel to the left while videoing a static scene so that the scene appears (to the person viewing the video) to move one pixel to the right. Even though two successive frames will look very similar, the correspondence on a position-by-position basis may not be high. A similar problem arises as a large object moves against a static background: the redundancy associated with the background can be reduced on a position-by-position basis, but the redundancy of the object as it moves is not exploited.

Some prevalent compression schemes, e.g., MPEG, encode “motion vectors” to address inter-frame motion. A motion vector can be used to map one block of pixel positions in a first “reference” frame to a second block of pixel positions (displaced from the first set) in a second “predicted” frame. Thus, a block of pixels in the predicted frame can be described in terms of its differences from a block in the reference frame identified by the motion vector. For example, the motion vector can be used to indicate the pixels in a given block of the predicted frame are being compared to pixels in a block one pixel up and two to the left in the reference frame. The effectiveness of compression schemes that use motion estimation is well established; in fact, the popular DVD (“digital versatile disk”) compression scheme (a form of MPEG2) uses motion detection to put hours of high-quality video on a 5-inch disk.

Identifying motion vectors can be a challenge. Translating a human visual ability for identifying motion into an algorithm that can be used on a computer is problematic, especially when the identification must be performed in real time (or at least at high speeds). Computers typically identify motion vectors by comparing blocks of pixels across frames. For example, each 16×16-pixel block in a “predicted” frame can be compared with many such blocks in another “reference” frame to find a best match. Blocks can be matched by calculating the sum of the absolute values of the differences of the pixel values at corresponding pixel positions within the respective blocks. The pair of blocks with the lowest sum represents the best match, the difference in positions of the best-matched blocks determine the motion vector. Note that in some contexts, the 16×16-pixel blocks typically used for motion detection are referred to as “macroblocks” to distinguish them from 8×8-pixel blocks used by DCT (discrete cosine transformations) transformations for intra-frame compression.

For example, consider two color video frames in which luminance (brightness) and chrominance (hue) are separately encoded. In such cases, motion estimation is typically performed using only the luminance data. Typically, 8-bits are used to distinguish 256 levels of luminance. In such a case, a 64-bit register can store luminance data for eight of the 256 pixels of a 16×16 block; thirty-two 64-bit registers are required to represent a full 16×16-pixel block, and a pair of such blocks fills sixty-four 64-registers. Pairs of 64-bit values can be compared using parallel subword operations; for example, PSAD “parallel sum of the absolute differences” yields a single 16-bit value for each pair of 64-bit operands. There are thirty-two such results, which can be added or accumulated, e.g., using ADD or accumulate instructions. In all, about sixty-four instructions, other than load instructions, are required to evaluate each pair of blocks.

Note that the two-instruction loop (PSAD+ADD) can be replaced by a one-instruction loop using a parallel sum of the absolute differences and accumulate PSADAC instruction. However, this instruction requires three operands (the minuend register, the subtrahend register, and the accumulate register holding the previously accumulated value). Three operand registers are not normally available in general-purpose processors. However, such instructions can be advantageous for application-specific designs.

The Intel Itanium processor provides for improved performance in motion estimation using one- and two-operand instructions. In this case, a three-instruction loop is used. The first instruction is a PAveSub, which yields half the difference between respective one-byte subwords of two 64-bit registers. The half is obtained by shifting right one bit position. Without the shift, nine bits would be required to express all possible differences between 8-bit values. So the shift allows results to fit within the same one-byte subword positions as the one-byte subword operands.

These half-differences are accumulated into two-byte subwords. Since eight half-differences are accumulated into four two-byte subwords, the bytes at even-numbered byte positions are accumulated separately from bytes at odd-numbered byte positions. Thus, a “parallel accumulate magnitude left” PAccMagL accumulates half-differences at byte positions 1, 3, 5, and 7, while a “parallel accumulate magnitude right” PAccMagR accumulates the half-differences at byte positions 0, 2, 4, and 6. This loop can execute more quickly than the two-instruction loop described above, as a final sum is not calculated within each loop iteration. Instead, the four 2-byte subwords are summed once after the loop iterations end.

The four two-byte subwords can be summed outside the loop using an instruction sequence as follows. First, the final result is shifted to the right thirty-two bits. Then the original and shifted versions of the final result are summed. Then the sum is shifted sixteen bits to the right. The original and shifted versions of the sum are added. If necessary, all but the least-significant sixteen bits can be masked out to yield the desired match measure.

While the foregoing programs for calculating match measures are quite efficient, further improvements in performance are highly desirable. The number of matches to be evaluated varies by orders of magnitude, depending on several factors, but there can easily be millions to evaluate for a pair of frames. In any event, the block matching function severely taxes encoding throughput. Further reductions in the processing burden imposed by motion estimation are desired.

### SUMMARY OF THE INVENTION

The present invention provides for programs that include intra-word subword-add instructions and data processors that execute them. As defined herein, an “intra-word subword-add instruction” is an instruction that yields as a result a function of a sum having as at least some of its addends unary functions of at least two subwords stored in the same register.

The invention provides for instructions for which the result is simply the sum of all subwords stored in a register. In this case, the functions referred to above are identity functions, i.e., f(x)=x. Different size subwords are provided for. Typically, the subwords are power-of-two fractions of the word size, but the invention is not limited to these. Also, the subwords operated on need not be the same size. By the definition applied herein, a “subword” must be larger than one bit and smaller than the word size.

Functions other than identity functions are provided for. For example, the unary functions of subwords can be absolute values. Likewise, the result can be the absolute value of the sum. Other applicable unary functions can be the two's complement, one's complement, increment, decrement, add a constant, subtract a constant, opposite, divide by two (shift right), multiply by two (shift left), etc.

The invention provides for involving all the subwords in a register in the addition. Alternatively, fewer than all, but at least two, can be involved. Furthermore, the addition can involve addends other than these subwords. The other addends can include one or more values from one or more other registers. For example, the subwords in one register can be added to subwords in another register and/or accumulated to a value stored in another register.

The invention can improve the performance of motion estimation programs having loops that perform parallel accumulation. For example, the program using the PAveSub, PAccMagL, and PAccMagR instructions discussed in the background yields a loop result with four subwords that need to be added. Instead of using the five-instruction “shift”-“add”-“mask” sequence to perform this addition, the present invention provides this sum using a single “TreeAdd” instruction to sum the four 16-bit subwords.

Moreover, the invention provides instructions that can be used within a loop for further enhancements in performing motion estimation. For example, the PAccMagR and PAccMagL instructions can be combined into a single PAccMagLR instruction to have one instruction per loop. An even more optimal solution uses a parallel accumulate instruction that accumulates pairs of one-byte subwords into a two-byte value using a parallel accumulate PAcc instruction with a parallel difference instruction PDiff. In this latter case, the absolute value is performed.

Dramatic further improvements in performance are also provided for. For example, pixel depth can be reduced to one-bit prior to block comparison. Registers storing values for sixty-four pixels each can be XORed; population counts of the number of 1s in each two-byte subword can be performed within the loop. Outside the loop accumulated population counts can be added using the TreeAdd instruction for a final result. These and other features and advantages of the invention are apparent from the description below with reference to the following drawings.

### BRIEF DESCRIPTION OF THE DRAWINGS

FIG. 1 is a schematic representation of a program segment used to calculate a block-match measure in accordance with the present invention.

FIG. 2 is a schematic representation of a data processing system in accordance with the present invention on which the program of FIG. 1 is executed.

FIG. 3 is a schematic representation of a PAccMagLR instruction used in an alternative program segment to calculate a block-match measure in accordance with the present invention.

FIG. 4 is a schematic representation of a TreeAdd1a instruction in accordance with the present invention.

FIG. 5 is a schematic representation of a TreeAdd2b instruction in accordance with the present invention.

FIG. 6 is a schematic representation of a TreeAdd2c instruction in accordance with the present invention.

FIG. 7 is a schematic representation of a TreeAdd2d instruction in accordance with the present invention.

FIG. 8 is a schematic representation of an AbsTreeAdd2a instruction in accordance with the present invention.

### DETAILED DESCRIPTION

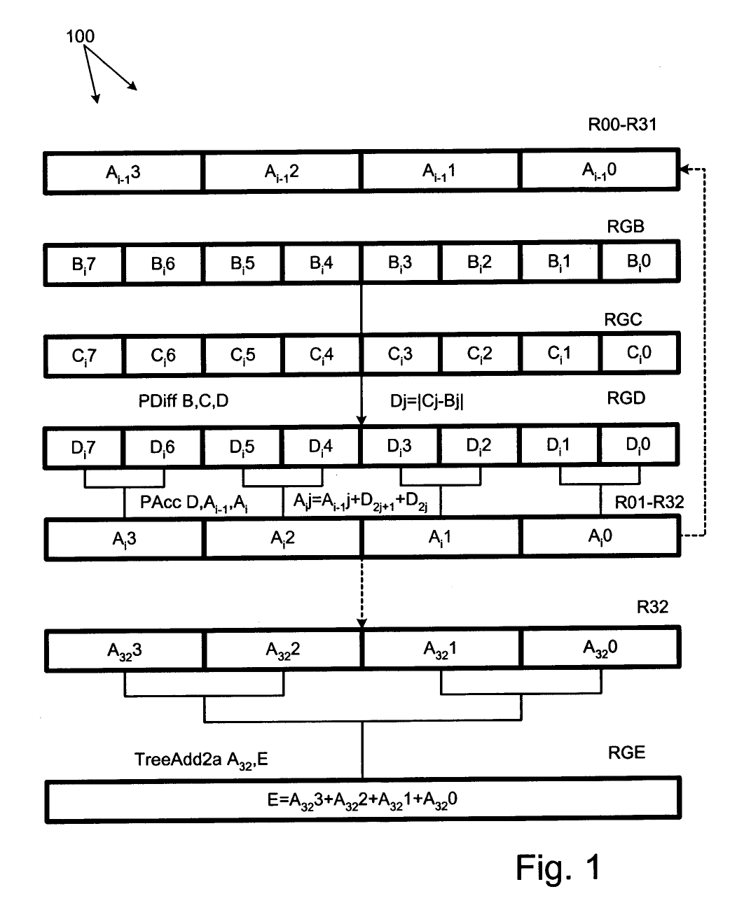

A segment of a video compression program 100 in accordance with the present invention is represented in FIG. 1. This program segment is designed to provide a block-match measure for two image blocks, one of which is typically a “predicted” block of an image to be compressed and the other of which is a “reference” block of a reference frame. The predicted block is to be compared with many reference blocks; the reference block with the best match to the predicted block determines a motion vector to be used in encoding the predicted block in a compressed format.

Each block consists of 256 pixels arranged in a 16×16-pixel array, with each pixel being assigned an 8-bit luminance value. The luminance values of pixels in corresponding pixel positions within the blocks are compared. The match measure is the sum across all pixel positions of the absolute values of the differences of the luminance values for pairs of pixels at corresponding positions of the reference and predicted image blocks.

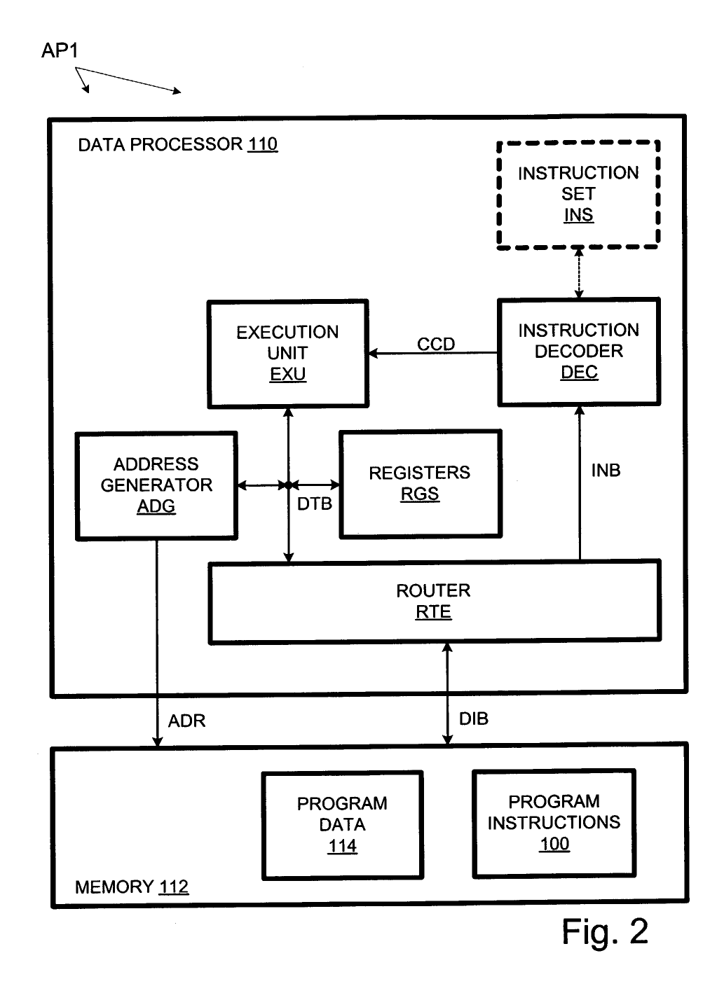

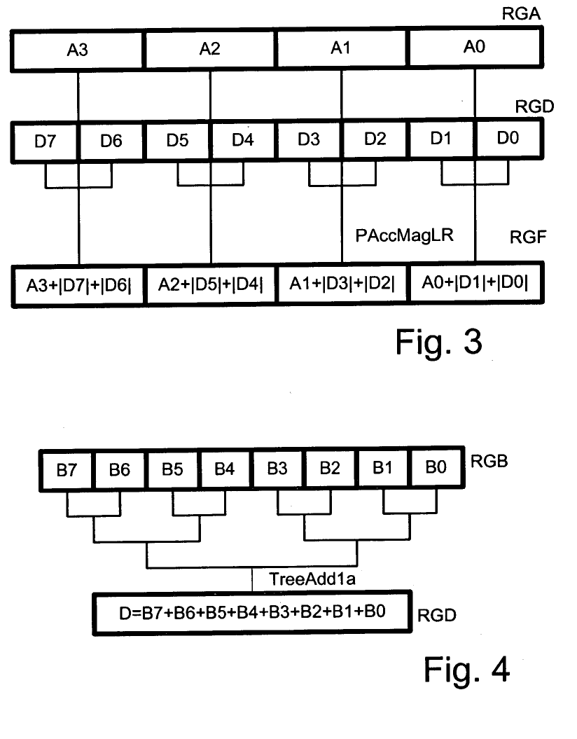

Program 100 is executed by computer system AP1, shown in FIG. 2, which comprises a data processor 110 and memory 112. The contents of memory 112 include program data 114 and instructions constituting a program 100. Microprocessor 110 includes an execution unit EXU, an instruction decoder DEC, registers RGS, an address generator ADG, and a router RTE. Unless otherwise indicated, all registers referred to hereinunder are included in registers RGS.

Generally, execution unit EXU performs operations on data 114 in accordance with program 100. To this end, execution unit EXU can command (using control lines ancillary to internal data bus DTB) address generator ADG to generate the address of the next instruction or data required along address bus ADR. Memory 112 responds by supplying the contents stored at the requested address along data and instruction bus DIB.

As determined by indicators received from execution unit EXU along indicator lines ancillary to internal data bus DTB, router RTE routes instructions to instruction decoder DEC via instruction bus INB and data along internal data bus DTB. The decoded instructions are provided to execution unit EXU via control lines CCD. Data is typically transferred in and out of registers RGS according to the instructions.

Associated with microprocessor 110 is a set of instructions INS that can be decoded by instruction decoder DEC and executed by execution unit EXU. Program 100 is an ordered set of instructions selected from instruction set INS. For expository purposes, microprocessor 110, its instruction set INS, and program 100 provide examples of all the instructions described below.

The first loop instruction is “parallel difference” instruction PDiff B,C,D. This instruction calculates the absolute values of the differences between 8-bit values stored at corresponding 1-byte subwords stored in specified registers RGB and RGC. These registers each hold one 64-bit word, so that eight 1-byte subword operations can be performed in parallel.

In the context of video compression, each 1-byte subword is an 8-bit luminance value for a pixel in one of the blocks being compared. Register RGB stores luminance values (Bᵢ0-Bᵢ7) for eight reference block pixels per iteration i, while register RGC stores luminance values (Cᵢ0-Cᵢ7) for the corresponding eight predicted block pixels per iteration. Thus, eight pixels are compared per loop iteration. The results (Dᵢ0-Dᵢ7) are stored in register RGD.

The second loop instruction is a “parallel accumulate” instruction PAcc D,i-1,i,. This instruction involves the parallel accumulation of four 2-byte (16-bit) values. To four 16-bit values stored in register Ri-1 are added corresponding pairs of 1-byte values stored in register RGD. The four 16-bit results are stored in register Ri. For the first iteration of the program loop, i=1 and the register R00 holds four 16-bit values, each of which is initialized to zero.

At the completion of the first iteration of the loop, register A01 holds four 16-bit partial sums, the sum of which is the sum of the absolute differences of the luminance values for the first eight pairs of pixels for the reference and predicted blocks. By refraining from calculating this final sum within the loop, loop execution time is shortened. This time saving is multiplied by the number of loop iterations, for a considerable improvement in program performance. As each loop iteration provides comparisons for eight pairs of pixels and as there are 256 pixel comparisons to be made per reference and predicted block pair, thirty-two loop iterations are required to compute a block match measure.

Each successive iteration accumulates pixel comparisons into the four 16-bit accumulated values. At the end of thirty-two iterations, all pixel comparisons for a block pair have been performed. One additional instruction TreeAdd2a 32,E is required to sum the accumulated 16-bit subwords into a single value E that serves as the match measure. Specifically, the instruction specifies that the four 2-byte values stored in register R32 are to be added, with the sum to be stored in RGE. This instruction is referred to as a “TreeAdd” instruction because the preferred data paths to implement the instruction illustrate a tree structure as roughly indicated in FIG. 1. However, the instruction can be implemented without using such a tree structure.

The TreeAdd2a instruction exemplifies the present invention. The result is a function of a sum of addends including unary functions of subwords of a word stored in a register. In this case, the functions are all identify functions: the result is simply the sum of the subwords of a single operand register.

The PAcc instruction also embodies the present invention as it involves the sum of a pair of subwords stored in the same register. In this case, the result is still a function of a sum that includes subwords as some of its addends. In the case of PAcc, each sum also includes a previously accumulated value as an addend.

The foregoing block measure is calculated using subtraction, absolute value, and addition iteratively. In the foregoing loop, absolute value is combined with subtraction (in the PDiff instruction). However, it can be combined alternatively with the addition. In this case, the loop can comprise the following two instructions:

PAveSub B,C,D

PAccMagLR A,D,F

PAveSub B,C,D performs eight 8-bit subtractions of 8-bit values (C0-C7) stored in register RGC from 8-bit values stored in register RGB (B0-B7). The 8-bit differences are shifted one-bit to the right, so that the result is one-half the difference. The purpose of the divide-by-two is to ensure the range of results of each 8-bit operation can be expressed as an 8-bit result. The eight parallel subword results (D0-D7) are stored in register RGD.

There is a loss of precision involved in the shift right operation. This loss of precision can result in a less than optimal selection of a motion vector. However, the impact on compression effectiveness is negligible.

PAccMagLR A,D,F calculates the absolute values of the 8-bit values stored in register RGD, adds the absolute values pair-wise, and accumulate the sums with 16-bit accumulated values in register RGA. The results are stored in register RGF.

At the end of thirty-two iterations of the PAccMagLR loop, all pixel pairs have been compared and partial results are stored as four 16-bit subwords. These can be added using the TreeAdd2a instruction, as with the loop of FIG. 1. In this case, the match measure is about half the match measure obtained in FIG. 1 due to the divide-by-two operation performed by PAveSub. The PAccMagLR instruction embodies the present invention because it involves the addition of unary functions of subwords stored in the same register. In this case, the unary function is the absolute value.

In the foregoing examples, 8-bit luminance values are compared to provide a block-match measure. However, the invention can also be used to compare blocks described with different numbers of bits per pixel. For example, 1-bit-per-pixel blocks can be compared. These can be monochrome images or multi-bit-per-pixel images compressed to 1-bit-per pixel for motion estimation purposes. As described in a concurrently filed application entitled “Image Matching Using Pixel-Depth Reduction Before Image Comparison”, Attorney Docket Number 10971661-1, such compression can greatly speed up motion estimation will very little penalty in terms of compression effectiveness.

One possible program sequence for comparing 1-bit per pixel 256-pixel blocks uses the following loop:

PSXOR2 A,B,C

ADD2 B,B,C

Registers RGA and RGB each include sixty-four one-bit values. These 64-bit values are XORed so that pixel positions at which pixel values differ are assigned a “1”, while pixel positions at which pixel values match are assigned a “0”. The 64-bit word of 1-bit values is treated as four 2-byte subwords. The number “1s” in each subword is counted, yielding four 16-bit counts that are stored as 2-byte subwords in register RGC. The four 2-byte counts are accumulated in parallel using the Add 2 instruction. At the end of four iterations of the loop, all 256 comparisons have been made. The TreeAdd2a instruction can then be used to generate the final match measure.

In the TreeAdd2a nomenclature, the “2” refers to two-byte subwords. However, the invention also applies to addition involving other subword sizes. Herein, by definition, subwords must include two or more bits; the concept of a 1-bit subword is considered meaningless. However, the redundant phrase “multi-bit subword” is sometimes used herein to avoid any misunderstanding. The TreeAdd1a instruction of FIG. 4 is an example of an embodiment of the invention applied to 1-byte subwords. The result of the TreeAdd1a instruction is a 64-bit sum of eight one-byte subwords stored in a specified operand register.

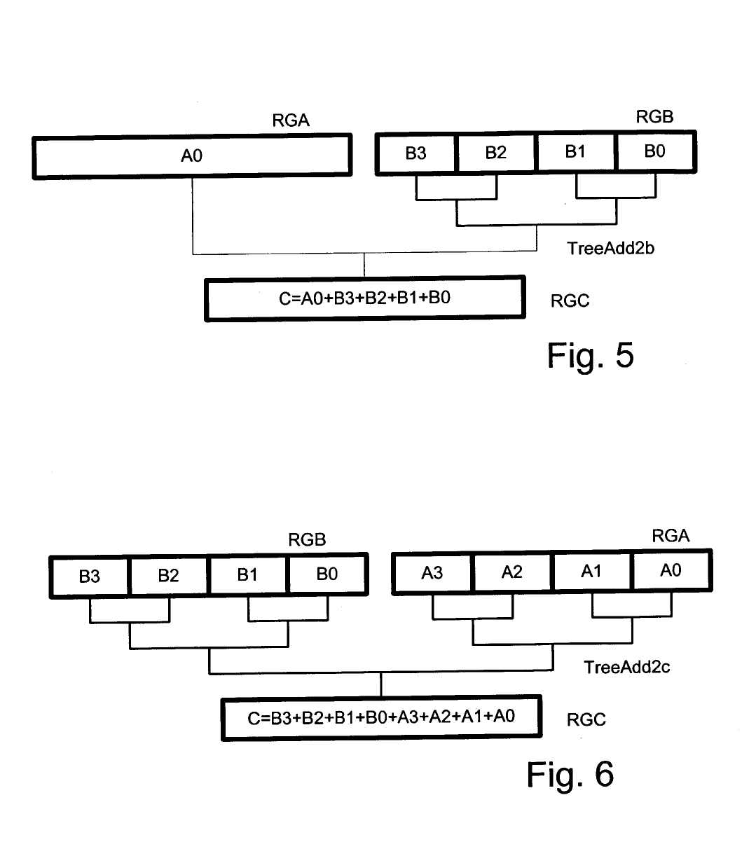

The “a” TreeAdd2a is used to differentiate different types of TreeAdd instructions. A TreeAdd2b instruction is illustrated in FIG. 5. Basically, it computes the same sum as TreeAdd2a, but then accumulates that sum with previously calculated sum of 16-bit subwords. Where TreeAdd2a specifies one operand register, TreeAdd2b specifies two operand registers. A TreeAdd2c instruction is represented in FIG. 6. It adds four 2-byte subwords of one register with four 2-byte subwords of another register. Again, two operand registers are specified.

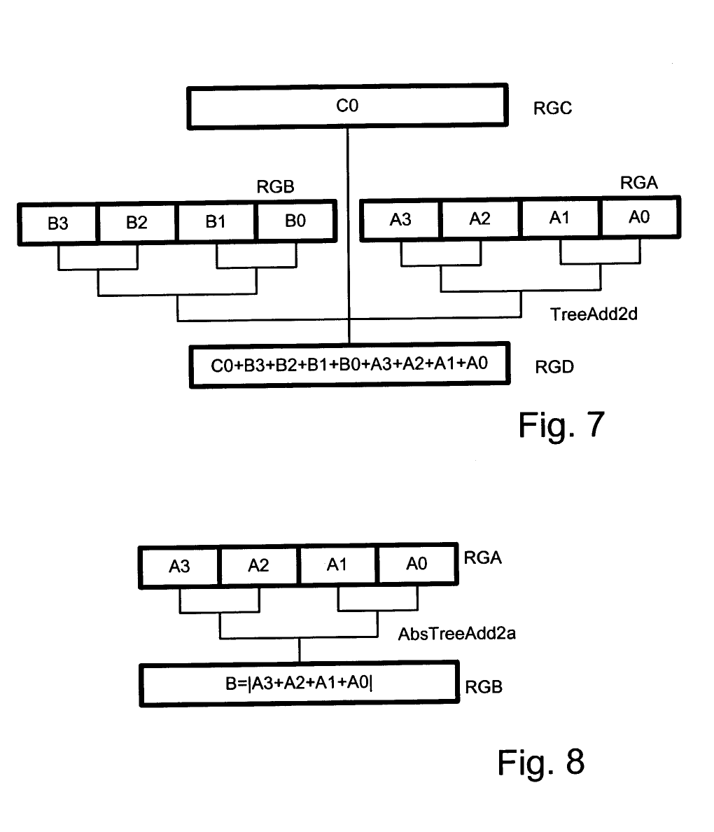

A TreeAdd2d instruction is represented in FIG. 7. It adds eight two-byte subwords stored in two registers and adds this sum to a previously calculated value. In a sense, the TreeAdd2d combines the functionality of the TreeAdd2b and the TreeAdd2c instructions. The TreeAdd2d requires three operand registers. Since general-purpose processors rarely provide for three-operand instructions, this instruction is primarily suitable for special-purpose processors.

An AbsTreeAdd2a instruction is represented in FIG. 8. This instruction is similar to TreeAdd2a except that the result is the absolute value of the sum of four two-byte subwords stored in a register. The AbsTreeAdd2a is an embodiment of the invention in which the result is not a sum, but a function of a sum. More generally, the invention provides instructions that yield a result.

These and other variations upon and modifications to the embodiments described above are provided for by the present invention, the scope of which is defined by the following claims.

What is claimed is:

1. A data processor comprising:
plural registers for storing data words, said plural registers including a first operand register storing an operand word having multi-bit subwords; and
an execution unit for executing an intra-word subword-add instruction having a result that is a function of a sum having unary functions of at least two said subwords as at least some of its addends.

2. A data processor as recited in claim 1 wherein said result is equal to the sum of said subwords.

3. A data processor as recited in claim 1 wherein said plural registers also include a second operand register, said result being equal to the sum of said subwords plus one or more values stored in said second operand register.

4. A data processor as recited in claim 1 wherein said execution unit also executes parallel subword instructions.

5. A data processor as recited in claim 1 wherein said word includes at least four mutually exclusive subwords, said instruction adding pairs of said subwords respectively to previously calculated subwords.

6. A data processor as recited in claim 1 wherein said second unary functions provide absolute values of said subwords.

7. A data processor as recited in claim 6 wherein said word includes at least four mutually exclusive subwords, said instruction adding pairs of absolute values of said subwords respectively to previously calculated subwords.

8. A data processor as recited in claim 1 wherein said function of a sum is a not an identity function.

9. A computer program comprising an intra-word subword-add instruction having a result that is a function of a sum having unary functions of at least two said subwords as at least some of its addends.

10. A computer program as recited in claim 9 including iterated loop with parallel subword instructions, said iterated loop providing a loop result having loop-result subwords, said intra-word subword-add instruction providing the sum of said loop-result subwords.

11. A computer program as recited in claim 9 including an iterated loop including said intra-word subword-add instruction.

12. A computer program as recited in claim 11 wherein said loop includes:
a parallel subword difference instruction that yields subword results, and
a parallel accumulate instruction that sums pairs of said subword results with respective predetermined values.

13. A computer program as recited in claim 11 wherein said loop includes:
a parallel subword instruction that yields subword results that are unary functions of differences between parallel subwords in two operand registers, and
a parallel accumulate instruction that sums previously calculated values with the absolute values of said subword results.

14. A computer program as recited in claim 9 wherein said function of a sum is not an identity function.
